(19) United States
(12) Patent Application Publication
(10) Pub. No.: US 2020/0182680 A1
(43) Pub. Date: Jun. 11, 2020

(54) METAL TANK ULTRASONIC LIQUID LEVEL SENSING

(71) Applicant: TEXAS INSTRUMENTS INCORPORATED, Dallas, TX (US)

(72) Inventors: Siva RaghuRam Prasad CHENNUPATI, Unterschliessheim (DE); Sandeep TALLADA, Bengaluru (IN)

(21) Appl. No.: 16/212,246

(22) Filed: Dec. 6, 2018

(51) Int. Cl. G01F 23/296

(52) U.S. Cl. CPC G01F 23/2962

(57) ABSTRACT

An ultrasonic system provides an inexpensive non-invasive way to measure fuel levels in a metal fuel tank that reduces noise from tank vibration. A first transducer generates a first signal that can be used to determine fuel levels in the tank. A second transducer placed on a chassis generates a second signal that corresponds to the noise. A differential amplifier then subtracts the second signal from the first signal, producing a cleaner signal result for determining fuel levels.

### TECHNICAL FIELD

The present invention relates to the field of ultrasonic sensing, and in particular to techniques for ultrasonic sensing of the level of liquid in a metal fuel tank.

### BACKGROUND ART

Ultrasonic techniques for sensing liquid level in a tank have become popular because they are easy to install, inexpensive, and do not come into contact with the fuel, in contrast to older technologies such as float valves. However, where the tank is metal, vibrations in the metal tank are modulated over the ultrasonic signal, causing problems with the liquid level determination. Although plastic fuel tanks or invasive approaches such as float valves can be used, those are more expensive and involve contact with the fluid, so are less desirable.

### SUMMARY

One general aspect includes an ultrasonic liquid level measurement device that comprises an analog front end circuit, configured to send an electrical pulse to a first transducer coupled to a tank configured for containing a liquid; and a differential amplifier, coupled to the analog front end circuit, configured to subtract a second signal from a first signal; and output a subtracted signal to the analog front end circuit, wherein the first signal is received from the first transducer and corresponds to ultrasonic waves generated by the first transducer to determine a level of the liquid in the tank, and wherein the second signal is received from a second transducer and corresponds to vibrations of the tank.

Another general aspect includes an ultrasonic liquid level measurement system that comprises a processing element; an analog front end circuit, coupled to the processing element; a first transducer, coupled to the analog front end circuit, configured to receive an electrical pulse transmitted by the analog front end circuit and convert the electrical pulse to vibrations causing ultrasonic waves in a tank configured for containing a liquid and generate a first signal corresponding to the ultrasonic waves; a second transducer, coupled to the analog front end circuit, configured to generate a second signal that corresponds to vibrations of the tank; and a differential amplifier, coupled to the analog front end circuit, configured to subtract the second signal from the first signal; and output a subtracted signal to the analog front end circuit.

Yet another general aspect includes a method of measuring a level of fluid in a metal tank that comprises transmitting an electrical pulse from an analog front end circuit to a first transducer disposed on a surface of the metal tank; converting the electrical pulse to vibrations by the first transducer causing ultrasonic waves in the metal tank; generating a first signal corresponding to an echo of the ultrasonic waves by the first transducer; generating a second signal by a second transducer, corresponding to vibrations of the metal tank; and subtracting the second signal from the first signal by a differential amplifier, outputting a subtracted signal to the analog front end circuit.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a graph illustrating transmitting a pulse and receiving an echo pulse according to one embodiment.

FIG. 2 is a graph illustrating noise corruption of a received echo pulse according to one embodiment.

FIG. 3A is a block diagram illustrating an ultrasonic liquid level measurement device according to one embodiment.

FIG. 3B is a block diagram illustrating placement of transducers in a vehicle according to one embodiment.

FIG. 4 is a graph illustrating subtraction of a noise signal from a received signal according to one embodiment.

FIG. 5 is a block diagram illustrating an ultrasonic liquid level measurement system according to one embodiment.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one aspect” or to “an aspect” means that a particular feature, structure, or characteristic described in connection with the aspects is included in at least one aspect of the invention, and multiple references to “one aspect” or “an aspect” should not be understood as necessarily all referring to the same aspect.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

The term “couple” or “couples” means either an indirect or direct wired or wireless connection. Thus, if a first device couples to a second device, that connection may be through a direct connection or through an indirect connection via other devices and connections. The recitation “based on” means “based at least in part on.” Therefore, if X is based on Y, X may be a function of Y and any number of other factors.

Ultrasonic time of flight (TOF) level measurement works by using a single piezoelectric transducer to create a pulse from the bottom of a tank. That pulse travels through the tank wall, through the fluid in the tank until it reaches the fluid surface. At the fluid surface (fluid to air interface) an echo is created. Measuring how long it takes for the echo to return is referred to as TOF measurement. The TOF measurement can be thought of as following the following equation:

$$time of flight = \frac{( 2 * fluid level )}{fluid speed of sound} .$$

The fluid level can therefore be calculated as:

$$fluid level = \frac{time of flight * fluid speed of sound}{2}$$

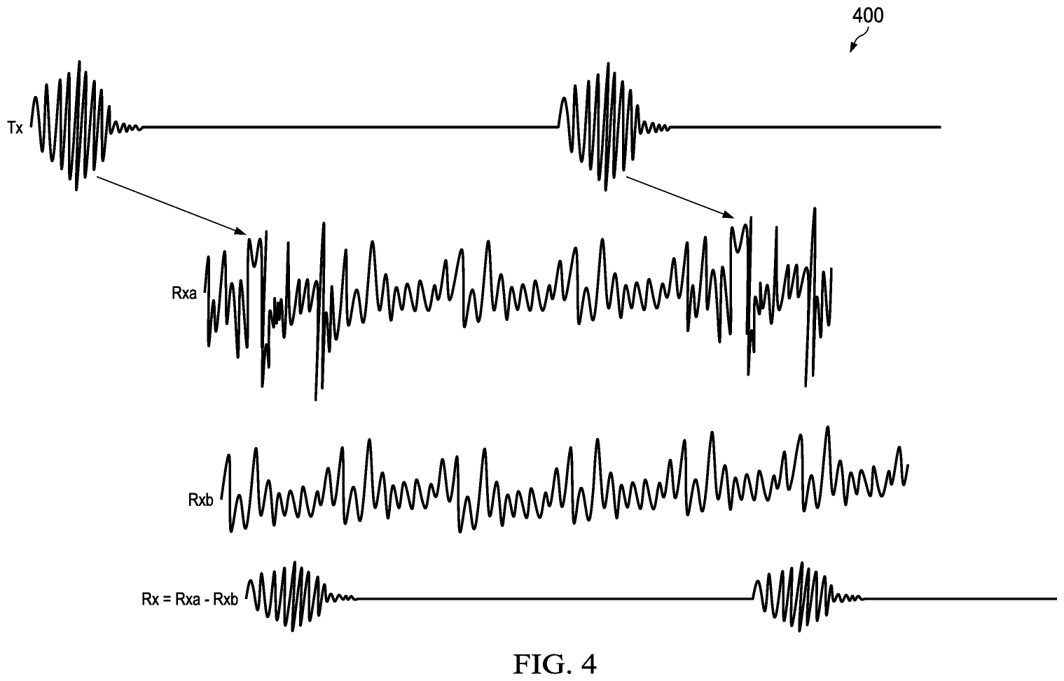

At the highest level an ultrasonic liquid level measuring system as described herein comprises a signal transmitter, a signal receiver, and a signal transmission path. The signal that needs to be detected reliably is the ultrasonic echo that is created at the acoustic boundary between the material level being measured (liquid) and the lack of it (air etc.). The ultrasonic TOF measurement system has 3 basic parts (as illustrated in FIG. 5), a piezo electric transducer, a microprocessor, and an analog front end (AFE) circuit that interfaces between the transducer and the microprocessor, ignoring standard elements such as power supplies, etc. The AFE drives the transducer with electrical pulses and converts the analog echo signals into digital signals that represent the beginning (START) and end (STOP) of the TOF measurement. The microprocessor controls the analog interface, measures the time delta between the Start and Stop signals and processes the TOF information created by the AFE into a liquid level value.

But for the AFE and microprocessor to create the START and STOP times and thus process the TOF and fluid level information, the AFE must be able to recognize the analog echo signals. Noise generated by vibrations of the tank itself may corrupt the signals from the transducer. While those vibrations in a plastic tank are generally not severe enough to create problems, when the tank is a metal tank, that noise signal can be severe enough that the AFE cannot reliably generate the START and STOP signals for the microprocessor. This has made ultrasonic level measurement infeasible on metal tanks until now.

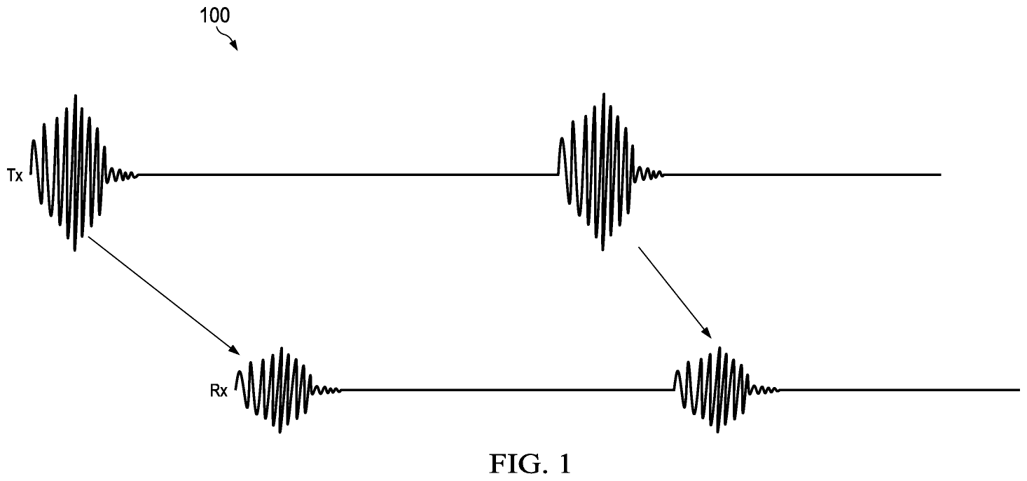

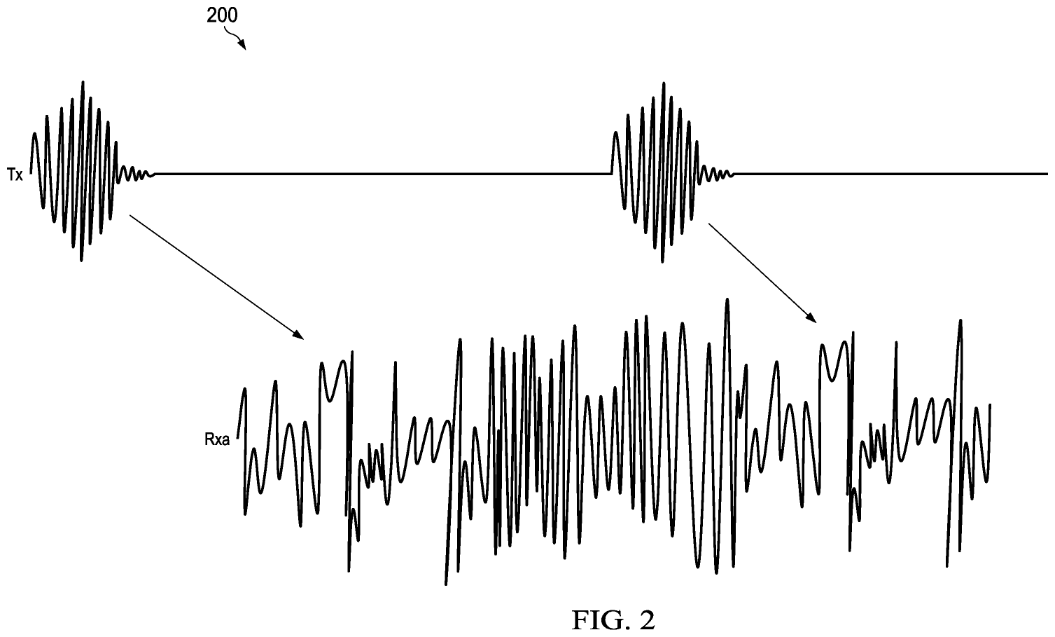

This can be seen by examination of the transmitted signal Tx and the received signal Rx in a perfect non-noisy environment 100 of FIG. 1. The burst in the Tx signal is accurately received a short time later in the Rx signal and can be recognized by the AFE. However, in a noisy environment such as the environment 200 of FIG. 2, the Tx signal is received as noisy received signal Rxa, in which the burst generated in the Tx signal cannot be recognized. The shape, frequency, and other characteristics of the Tx signal bursts are illustrative and by way of example only, and any signal burst may be used as desired.

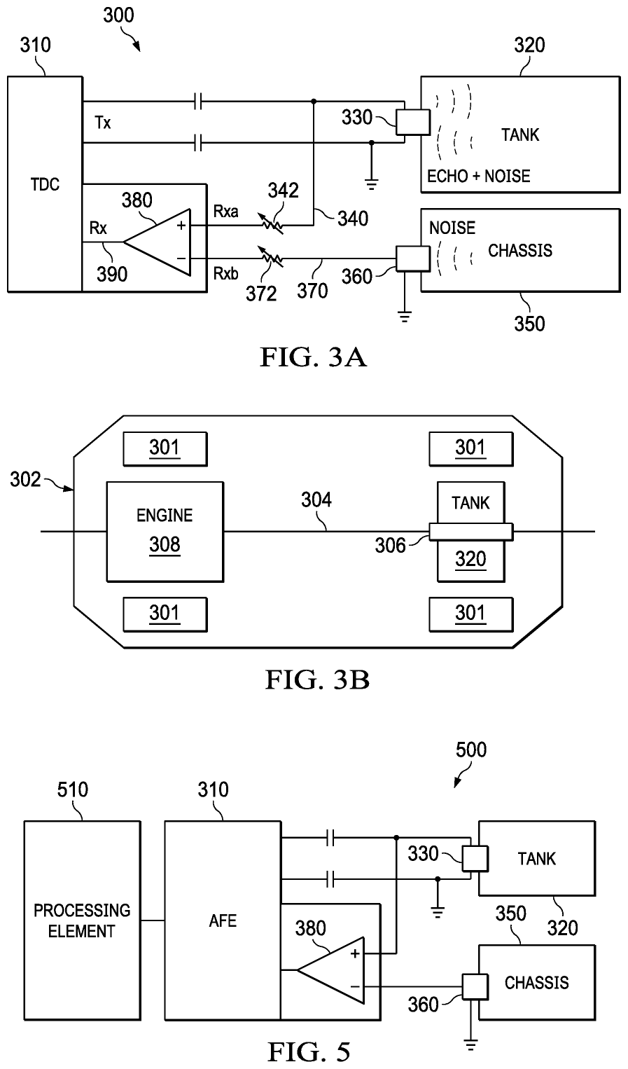

FIG. 3A is a block diagram illustrating an ultrasonic liquid level measurement device 300 of an ultrasonic level measuring system according to one embodiment that reduces or eliminates the noise from the Tx signal, allowing the AFE to recognize the transmitted bursts and generate the START and STOP data needed for calculating the fluid level. In this example, AFE 310 is a time-to-digital converter circuit, such as a TDC1000 from Texas Instruments, Inc., configured to receive an analog signal and output a time of arrival of a pulse in the analog signal. The AFE 310 outputs the START signal as the time when the pulse is transmitted to the transducer 330, and the STOP signal as the time when the echo signal is received from the transducer 330. Transducer 330 is placed on the wall of tank 320 and configured for generating ultrasonic waves in the tank 320 as driven by the AFE 310 and for generating an analog signal 340 from the echo ultrasonic waves in the tank 320. Thus, the signal 340 corresponds to the fluid level in the tank 320.

In addition, a second transducer 360 is disposed on a surface of a chassis 350 to which the tank 320 is mounted, and configured to generate an analog signal Rxb 370 from vibrations impinging on the transducer 360 through the chassis surface. Although the signal Rxb 370 is generated by the second transducer 360 based on vibrations of the chassis 350, the chassis vibrations correspond to the vibrations of the tank 320 itself, because vibrations of the chassis 350 induce vibrations in the tank 320 mounted on the chassis 350. Thus, the signal Rxb 370 indirectly corresponds to the vibrations of the tank 320.

Noisy returned signal Rxa 340 is delivered to a positive input of differential amplifier 380 from the transducer 330. The second returned signal Rxb 370 is delivered to a negative input of the differential amplifier 380 from transducer 360. The differential amplifier 380 is configured to subtract the Rxb signal 370 from the Rxa signal 340, producing output Rx signal 390 that is delivered to the AFE 310. Because the vibrations of the chassis 350 would be transmitted as vibrations to the tank 320, generating the noise that corrupts the Rxa signal 340, the Rx signal thus effectively eliminates the noise in the Rxa signal, allowing the AFE 310 to generate the START and STOP data that can be used to calculate TOF and thus the level of the fluid in tank 320. In some embodiments, the differential amplifier 380 may be integrated into the AFE 310.

The effect of the second transducer 360 and subtraction of signal Rxb 370 from signal Rxa 340 is illustrated in the graphs 400 of FIG. 4. The Tx signal generates signal bursts as in FIGS. 1-2, and the Rxa signal contains the noisy signal produced by vibrations in the tank 320. But now the noise signal Rxb can be subtracted from the received signal Rxa, producing the signal Rx in the bottom line of graph 400, a signal that is now clean enough for the AFE 310 to generate the START and STOP information. This makes use of ultrasonic level measurement possible on metal tanks 320 that could not use ultrasonic level measurement techniques previously.

The transducer 360 should be placed on the chassis 350 at a position where the background noise or vibration is present, and the best position may be determined empirically by measuring comparing the noise signal Rxb 370 with a signal from transducer 330 when no bursts are being generated by AFE 310, and finding a location where those two signals most closely match.

FIG. 3B is a block diagram illustrating placement of the transducers 320 and 360 according to one embodiment. In this embodiment, transducer 320 is placed on the tank 320 of vehicle 302 and transducer 360 is placed on the chassis 350, with both placed on or close to symmetric axis 304 of the vehicle 302, putting the transducers 320 and 360 approximately equal distance from noise sources like wheels 301 and engine 308, such as in area 306. Placement of the transducers 320 and 360 in area 306 can limit the need for lag or delay compensation. Otherwise, one of the signals 370 and 340 may need to include delays to compensate for lag between the vibrations generated by the transducer 320 and the transducer 360.

Similarly, transducers 320 and 360 are preferably oriented in the same direction to reduce the need for phase compensation between signals 370 and 340. Because the signals 340 and 370 may not be of the same amplitude, one or more of resistors 342 and 372 may be used to provide amplitude compensation. In one implementation, the resistors 342 and 372 may be programmable, allowing them to be adjusted to eliminate noise in signal Rx 390.

FIG. 5 is a block diagram illustrating an ultrasonic level measurement system 500 according to the embodiment of FIG. 3A that further includes a processing element 510 that can receive the time signals produced by AFE 310 and can use the equations set forth above to compute the fluid level in the tank 320. Conventional elements such as a power supply are omitted from FIG. 5 for clarity of the drawing. The fluid level output of processing element 510 can be provided to any receiver desired, such as a unit for displaying the fluid level in the tank 320.

The ultrasonic level measurement system described above can be used for any type of fluid in any type of metal tank, such as an automotive or other metal tank containing liquid for the automobile or other apparatus. The processing element 510 may be programmed with information about the type of fluid, such as the speed of sound for the fluid to be contained in tank 320, allowing the START and STOP information to be used to calculate the fluid level according to the equations set forth above. However, embodiments may be used for other types of liquids and other types of tanks. Although described herein as a metal tank, the ultrasonic level measurement system described herein can be used with non-metal tanks.

In some embodiments, the processing element 510 may be a microprocessor or any other type of programmable processor. In other embodiments, an application specific integrated circuit (ASIC) or a field programmable gate array (FPGA) may be used as the processing element 510.

Modifications are possible in the described embodiments, and other embodiments are possible, within the scope of the claims. While certain exemplary aspects have been described in detail and shown in the accompanying drawings, it is to be understood that such aspects are merely illustrative of and not devised without departing from the basic scope thereof, which is determined by the claims that follow.

We claim:

1. An ultrasonic liquid level measurement device, comprising:
an analog front end circuit, configured to send an electrical pulse to a first transducer coupled to a tank configured for containing a liquid; and
a differential amplifier, coupled to the analog front end circuit, configured to:
subtract a second signal from a first signal; and
output a subtracted signal to the analog front end circuit,
wherein the first signal is received from the first transducer and corresponds to ultrasonic waves generated by the first transducer to determine a level of the liquid in the tank, and
wherein the second signal is received from a second transducer and corresponds to vibrations of the tank.

2. The ultrasonic liquid level measurement device of claim 1, further comprising:
a programmable resistor, coupled to an input of the differential amplifier for amplitude compensation.

3. The ultrasonic liquid level measurement device of claim 1, wherein the differential amplifier is integrated into the analog front end circuit.

4. The ultrasonic liquid level measurement device of claim 1, wherein the second transducer is disposed on a surface of a chassis on which the tank is mounted.

5. The ultrasonic liquid level measurement device of claim 1, wherein the electrical pulse when received by the first transducer causes the first transducer to generate ultrasonic waves in the tank.

6. The ultrasonic liquid level measurement device of claim 1, wherein the analog front end circuit is a time-to-digital converter circuit.

7. The ultrasonic liquid level measurement device of claim 6, wherein the time-to-digital converter circuit is configured to receive the subtracted signal from the differential amplifier and generate signals indicating a time transmitting the electrical pulse to the first transducer and a time of receiving the subtracted signal from the differential amplifier.

8. An ultrasonic liquid level measurement system, comprising:
a processing element;
an analog front end circuit, coupled to the processing element;
a first transducer, coupled to the analog front end circuit, configured to receive an electrical pulse transmitted by the analog front end circuit and convert the electrical pulse to vibrations causing ultrasonic waves in a tank configured for containing a liquid and generate a first signal corresponding to the ultrasonic waves;
a second transducer, coupled to the analog front end circuit, configured to generate a second signal that corresponds to vibrations of the tank; and
a differential amplifier, coupled to the analog front end circuit, configured to:
subtract the second signal from the first signal; and
output a subtracted signal to the analog front end circuit.

9. The ultrasonic liquid level measurement system of claim 8, wherein the tank is metal fuel tank and the liquid is a liquid fuel.

10. The ultrasonic liquid level measurement system of claim 8, wherein the differential amplifier is integrated into the analog front end circuit.

11. The ultrasonic liquid level measurement system of claim 8, wherein the second transducer is disposed on a surface of a chassis on which the tank is mounted, and wherein the second signal is generated responsive to vibrations of the chassis that induce vibrations in the tank.

12. The ultrasonic liquid level measurement system of claim 8, further comprising:
a programmable resistor, coupled to an input of the differential amplifier for amplitude compensation.

13. The ultrasonic liquid level measurement system of claim 8, wherein the analog front end circuit is a time-to-digital converter circuit.

14. The ultrasonic liquid level measurement system of claim 13, wherein the time-to-digital converter circuit is configured to receive the subtracted signal from the differential amplifier and generate signals indicating a time of transmitting the electrical pulse to the first transducer and a time of receiving the subtracted signal from the differential amplifier.

15. The ultrasonic liquid level measurement system of claim 14, wherein the processing element is programmed to calculate a fluid level in the tank based on the time of transmitting the electrical pulse to the first transducer and a time of receiving the subtracted signal from the differential amplifier.

16. A method of measuring a level of fluid in a metal tank, comprising:
transmitting an electrical pulse from an analog front end circuit to a first transducer disposed on a surface of the metal tank;
converting the electrical pulse to vibrations by the first transducer causing ultrasonic waves in the metal tank;
generating a first signal corresponding to an echo of the ultrasonic waves by the first transducer;
generating a second signal by a second transducer, corresponding to vibrations of the metal tank; and
subtracting the second signal from the first signal by a differential amplifier, outputting a subtracted signal to the analog front end circuit.

17. The method of claim 16, further comprising: compensating for amplitude differences between the first signal and the second signal with one or more programmable resistors.

18. The method of claim 16, further comprising integrating the differential amplifier into the analog front end circuit.

19. The method of claim 16, further comprising:
positioning the first transducer and the second transducer on or close to a symmetric axis of a vehicle on which the metal tank is mounted; and
orienting the first transducer and the second transducer in a common direction.

20. The method of claim 16, further comprising:
calculating a fluid level in the metal tank based on a time of flight calculated based on a time of the electrical pulse transmitted by the analog front end circuit and a time of receiving the subtracted signal.
